(19) United States
(12) Patent Application Publication
(10) Pub. No.: US 2026/0259861 A1
(43) Pub. Date: Sep. 3, 2026

(54) METADATA IN A CONTAINER OBJECT OF A DEDUPLICATION STORAGE SYSTEM

(71) Applicant: Hewlett Packard Enterprise Development LP, Spring, TX (US)

(72) Inventors: Richard Phillip Mayo, Bristol (GB); Peter Thomas Camble, Bristol (GB)

(21) Appl. No.: 19/068,311

(22) Filed: Mar. 3, 2025

(51) Int. Cl. G06F 16/215

(52) U.S. Cl. CPC G06F 16/215

(57) ABSTRACT

Example implementations relate to deduplication operations in a storage system. An example includes receiving a stream of data units to be stored in a persistent storage of a deduplication storage system, and generating a manifest to record a received order of the data units. The example also includes storing the data units in a first container entity group (CEG) object, and storing a first set of metadata in a first container index, where the first set of metadata includes, for each data unit, a plurality of metadata fields regarding the data unit. The example also includes storing a second set of metadata in a header of the first CEG object, where the second set of metadata includes, for each data unit, a subset of the plurality of metadata fields regarding the data unit.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIG. 1 is a schematic diagram of an example storage system, in accordance with some implementations.

FIG. 2 is an illustration of example data structures, in accordance with some implementations.

FIG. 3 is an illustration of an example process, in accordance with some implementations.

FIG. 4 is an illustration of an example process, in accordance with some implementations.

FIG. 5 is an illustration of an example process, in accordance with some implementations.

FIG. 6 is an illustration of an example process, in accordance with some implementations.

FIG. 7 is an illustration of an example process, in accordance with some implementations.

FIG. 8 is a schematic diagram of an example computing device, in accordance with some implementations.

FIG. 9 is an illustration of an example process, in accordance with some implementations.

FIG. 10 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may receive a data stream from an external data source or system, and may store or “backup” a copy of the data stream. For example, the data stream may be generated by a backup system or program during a backup of a collection of data. The data stream may include discrete data units (or “chunks”) that are generated by the data source. Additionally (or alternatively), the data stream may include fingerprints that represent the data units, and that are generated by the external data source. As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

in some examples, the storage system may backup at least a portion of the data stream in deduplicated form, to thereby reduce the amount of storage space occupied by storage of the data stream. The storage system may create a “backup item” to represent a data stream in a deduplicated form. The storage system may perform a deduplication process including comparing the fingerprints of incoming data units to fingerprints of stored data units, and determining which incoming data units (if any) are duplicates of previously stored data units (e.g., when the comparison indicates matching fingerprints). In the case of data units that are duplicates, the storage system may store references to previously stored data units instead of storing the duplicate incoming data units. A process for receiving and deduplicating an inbound data stream may be referred to herein as a “data ingest” process of a storage system.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof. A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a deduplication storage system may use metadata structures for processing inbound data streams (e.g., backup items). For example, such metadata structures may include data recipes (also referred to herein as “manifests”) that specify the order in which particular data units are received for each backup item. Further, such metadata may include item metadata to represent each received backup item (e.g., a data stream) in a deduplicated form. The item metadata may include identifiers for a set of manifests, and may indicate the sequential order of the set of manifests. The processing of each backup item may be referred to herein as a “backup process.” Subsequently, in response to a read request, the deduplication system may use the item metadata and the set of manifests to determine the received order of data units, and may thereby recreate the original data stream of the backup item. Accordingly, the set of manifests may be a representation of the original backup item.

In some examples, the manifests may include a sequence of records, with each record representing a particular set of data unit(s). The records of the manifest may include one or more fields that identify container indexes that include metadata for the data units. For example, a container index may include one or more metadata fields that specify fingerprints for the stored data units, storage address information (e.g., containers, offsets, etc.) for the stored data units, compression and/or encryption characteristics of the stored data units, and so forth. Further, the container index may include reference counts that indicate the number of manifests that reference each data unit.

In some examples, upon receiving a data unit (e.g., in a data stream), it may be matched against one or more container indexes to determine whether an identical data unit is already stored in a container of the storage system. For example, the storage system may compare the fingerprint of the received data unit against the fingerprints in one or more container indexes. As used herein, the term “matching operation” may refer to an operation to compare fingerprints of a collection of multiple data units (e.g., from a particular backup data stream) against fingerprints stored in one or more container indexes. If no matching fingerprints are found in the searched container index(es), the received data unit may be stored in a container entity group (“CEG”) object, and a metadata entry for the received data unit may be added to a container index associated with that CEG object. However, if a matching fingerprint is found in a searched container index, it may be determined that a data unit identical to the received data unit is already stored in an existing CEG object. In response to this determination, the reference count of the corresponding entry may be incremented, and the received data unit is not stored in a CEG object (as it is already present in the existing CEG object), thereby avoiding storing a duplicate data unit in the storage system.

In some examples, a deduplication storage system may store CEG objects and associated metadata objects in a remote storage (e.g., a “cloud” or network storage service), rather than in a local filesystem. In such examples, processing a read request for a stored data unit may include loading the appropriate manifest from remote storage into memory, reading the manifest to identify the appropriate container index, loading the container index from remote storage into memory, reading the container index to determine the storage address of the data unit (e.g., a specific location in a particular CEG object), loading the CEG object from the remote storage into memory, and then reading the data unit from the location in the CEG object.

In some examples, the container indexes may be the only metadata structures in the deduplication storage system that store the fingerprints of the data units. Accordingly, if a container index becomes corrupted (e.g., due to a malware attack, a storage device failure, etc.), the deduplication storage system may be unable to access and use the fingerprints in the corrupted container index (e.g., for matching operations). Further, because the fingerprints are generated by the external data source, the deduplication storage system may be unable to restore the fingerprints in the corrupted container index. Accordingly, the deduplication storage system may be unable to deduplicate the data units indexed in the corrupted container index.

In accordance with some implementations of the present disclosure, a controller of a deduplication storage system may receive a data unit at initial ingest (e.g., when the data unit is first received), and may store the data unit in a container entity group (“CEG”) object. The controller may also generate metadata for the data unit, and may store this data unit metadata in a container index. The data unit metadata may include at least a fingerprint, location information, compression and/or encryption characteristics, and a reference count for the data unit. Further, the controller may store a metadata subset (e.g., a subset of the container index metadata) in the CEG object. In some implementations, the metadata subset may be stored in a header portion of the CEG object. Subsequently, in order to access the stored data unit (e.g., in response to a read request), the controller may identify the CEG object that stores the data unit, and may load the metadata subset of the CEG object from persistent storage into memory. The controller may read the metadata subset to determine the location (e.g., offset and length) of the data unit stored in the CEG object, and may then access the data unit using the determined location. In this manner, the controller may access the data unit without having to load the container index from persistent storage into memory (i.e., to determine the storage address of the data unit being accessed). Accordingly, some implementations may reduce the number of data transfers from storage to memory may be reduced, and may thereby improve the performance of the deduplication storage system.

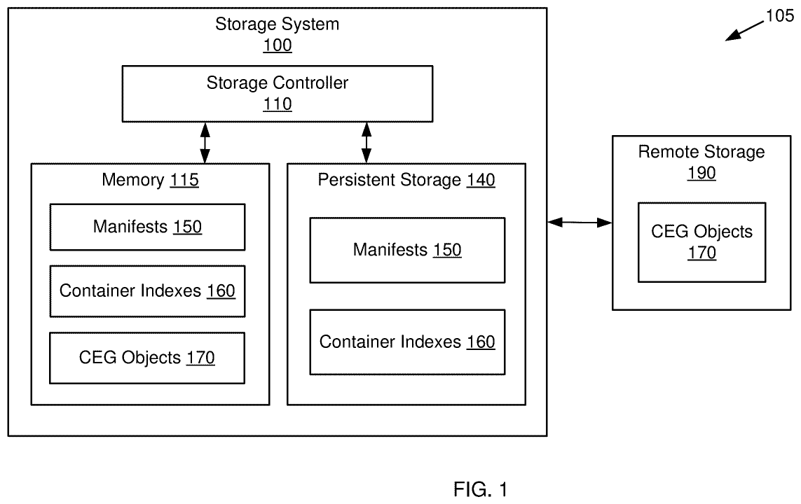

Further, some implementations, the metadata subset of the CEG object may be used to replace a lost or corrupted container index. The controller may identify a set of container entity group (CEG) objects associated with the lost container index, load the metadata subset (e.g., in a header portion) of the CEG object into memory, and populate the metadata subset into a replacement container index. The controller may then identify a set of manifests that each include at least one reference to the lost container index, determine the total reference counts in the identified set of manifests, and then populate the reference counts into the replacement container index. In this manner, the replacement container index is populated with the same metadata that would have been stored in the lost container index, and can then be used for deduplication of stored data. Various details of the disclosed techniques are discussed below with reference to FIGS. 1-10.

### FIG. 1—Example Storage System

FIG. 1 shows an example system 105 that includes a storage system 100 and a remote storage 190. The storage system 100 may include a storage controller 110, memory 115, and persistent storage 140, in accordance with some implementations. The storage system 100 may be coupled to the remote storage 190 via a network connection. The remote storage 190 may be a network-based persistent storage facility or service (also referred to herein as “cloud-based storage”). In some examples, use of the remote storage 190 may incur financial charges that are based on the number of individual transfers.

The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium). In some implementations, the memory 115 may include manifests 150, container indexes 160, and container entity group (“CEG”) objects 170. Further, the persistent storage 140 may store manifests 150 and container indexes 160. The remote storage 190 may persistently store CEG objects 170. Each CEG object 170 may be a container data structure configured to store multiple data units. In some examples, copies of the manifests 150, container indexes 160, and CEG objects 170 may be transferred between some or all of the memory 115, the persistent storage 140, and the remote storage 190 (e.g., via read and write input/output (I/O) operations).

In some implementations, the storage system 100 may perform deduplication of the stored data. For example, the storage controller 110 may receive a stream of data units, and may include at least one copy of each data unit in at least one of the CEG objects 170. The storage controller 110 may generate a manifest 150 to record the order in which the data units were received in the data stream. The manifest 150 may include pointers or other information indicating other data structures that include metadata for each data unit (also referred to herein as “data unit metadata”). For example, the manifest 150 may include, for each data unit, an identifier for the container index 160 associated with the data unit, an identifier for the CEG object 170 associated with the data unit, and so forth. In some implementations, the identifier for the container index 160 may be embedded in (e.g., may be a sub-portion of) the identifier for a CEG object 170.

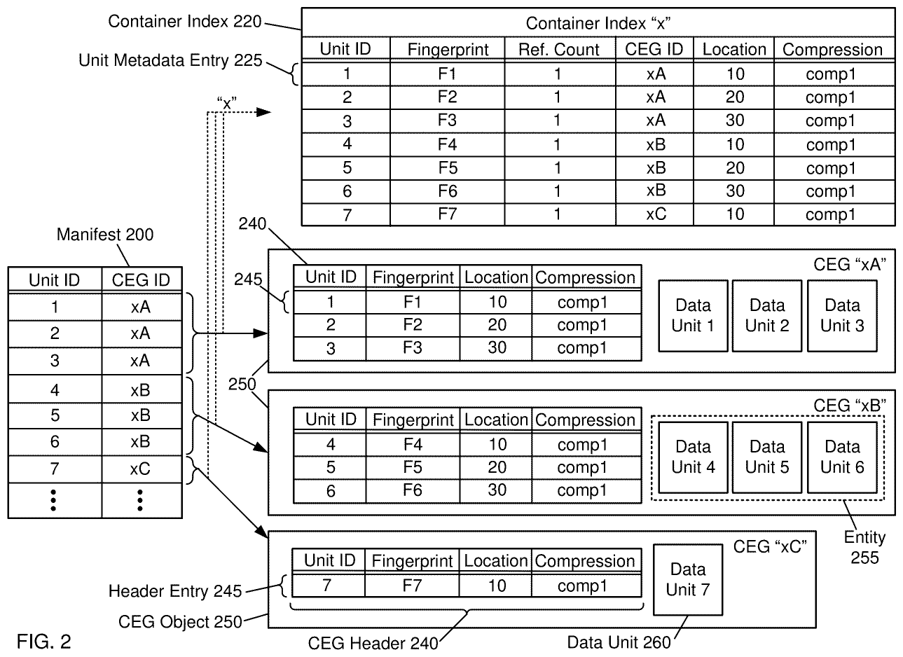

In some implementations, the container index 160 may include data unit metadata for each of a plurality of data units. For example, the data unit metadata may include a fingerprint (e.g., a hash) of a stored data unit for use in a matching process of a deduplication process. The data unit metadata may also include storage address information for each data unit (e.g., a location in a particular CEG object). Further, the data unit metadata may include a reference count of a data unit (e.g., indicating the number of manifest records that reference each data unit) for use in housekeeping (e.g., to determine whether to delete a stored data unit). Furthermore, the data unit metadata may include compression information, encryption information, and so forth. In some implementations, the CEG object 170 may include a metadata subset for each data unit that is stored in the CEG object 170. For example, a header portion of the CEG object 170 may include at least some of the data unit metadata fields that are stored in the container index 160, but may exclude the reference count and the CEG object identifier. Example implementations of a manifest 150, a container index 160, and CEG objects 170 are discussed further below with reference to FIG. 2.

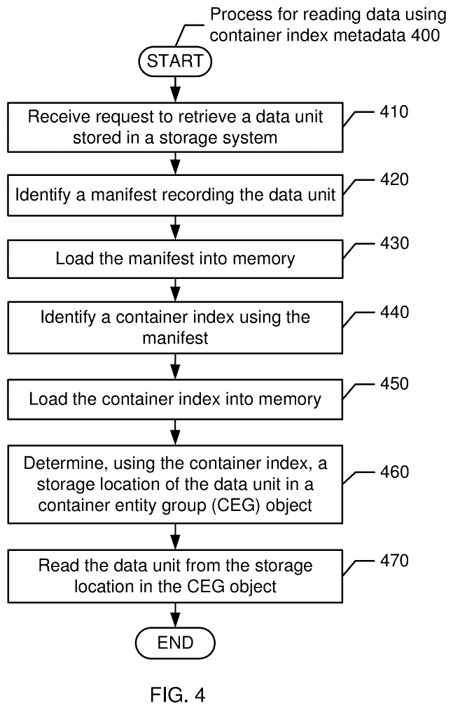

In some implementations, the storage controller 110 may access a stored data unit using container index path or a CEG path. The container index path may include accessing a manifest 150 that records the received order of the data unit, and using the manifest 150 to identify the container index 160 that includes metadata indicating the storage address of the data unit. For example, the container index 160 may include a first metadata field that identifies a CEG object 170, and second metadata field indicating that the data unit is stored at a particular location or offset in the CEG object 170 (identified in the first metadata field). Further, the container index path may include reading the data unit from the determined storage address (e.g., in the remote storage 190). An example processes for reading a data unit using container index metadata is discussed below with reference to FIG. 4.

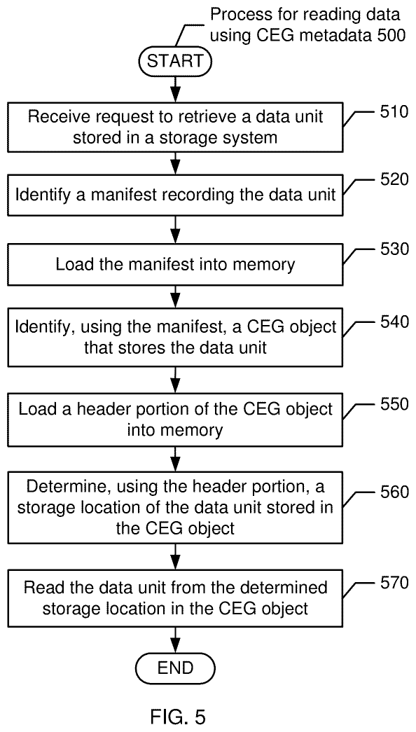

In some implementations, the CEG path may include using the manifest 150 to identify the CEG object 170 that includes metadata indicating the storage location of the data unit. For example, the identified CEG object 170 may include a header field indicating that the data unit is stored at a particular offset in the same CEG object 170. Further, the CEG path may include reading the data units from the determined storage location. In some implementations, the CEG path may be used to determine the storage addresses of the data units without loading the container index 160 into the memory 115. An example processes for reading a data unit using the CEG object metadata is discussed below with reference to FIG. 5.

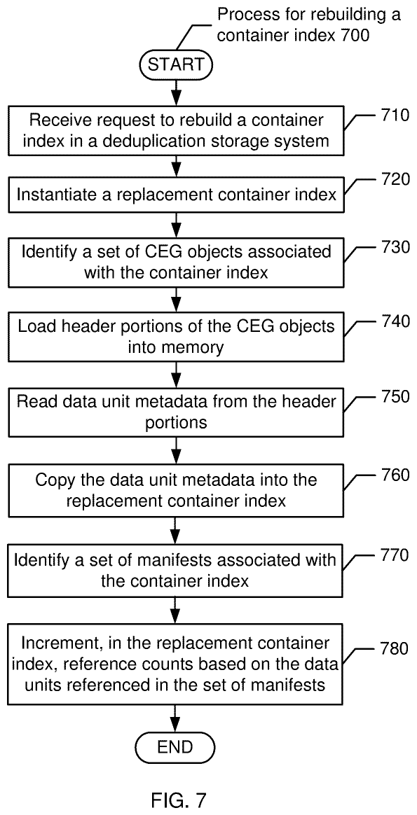

Further, some implementations, the CEG object metadata may be used to replace a lost or corrupted container index. The controller may identify a set of CEG objects associated with the lost container index, load the metadata subset of the CEG object into memory, and populate the metadata subset into a replacement container index. The controller may then identify a set of manifests that each include at least one reference to the lost container index, determine the total reference counts in the identified set of manifests, and then populate the reference counts into the replacement container index. In this manner, the replacement container index is populated with the same metadata that would have been stored in the lost container index, and can then be used for deduplication of stored data. An example processes for replacing a container index is discussed below with reference to FIG. 7.

Note that, while FIG. 1 shows one example, implementations are not limited in this regard. For example, it is contemplated that some or all of the manifests 150 and container indexes 160 may be stored in the remote storage 190. In another example, it is contemplated that some or all of the CEG objects 170 may be stored in the persistent storage 140. In yet another example, it is contemplated that the memory 115, persistent storage 140, and/or remote storage 190 may include other data objects or metadata. Further, it is contemplated that the storage system 100 may include additional devices and/or components, fewer components, different components, different arrangements, and so forth.

### FIG. 2—Example Data Structures

FIG. 2 shows an illustration of example data structures used in deduplication, in accordance with some implementations. As shown, the data structures may a manifest 200, a container index 220, and container entity group (“CEG”) objects 250. In some examples, the manifest 200, the container index 220, and the CEG objects 250 may correspond generally to example implementations of a manifest 150, a container index 160, and a CEG object 170 (shown in FIG. 1), respectively. Further, in some examples, the data structures 200, 220, 250 may be generated and/or managed by the storage controller 110 (shown in FIG. 1).

In some implementations, a manifest 200 may include multiples entries or “records” that are associated with different data units (e.g., a sequence of data units received in a data stream). For example, each record in the manifest 200 may include a data unit identifier (“Unit ID”) and a CEG identifier (“CEG ID”). The data unit identifier may be a numerical value (referred to as the “arrival number”) that indicates the sequential order of arrival (also referred to as the “ingest order”) of data units being added to a deduplication storage system (e.g., system 105 shown in FIG. 1). Further, the CEG identifier may identify the CEG object 250 that stores a copy of the data unit. In some implementations, the CEG identifier may include or encode an identifier for the container index 220. For example, as shown in FIG. 2, each CEG identifier (e.g., “xA,” “xB,” “xC”) may include a prefix (e.g., “x”) or other embedded portion that identifies the container index 220 (e.g., container index “x”) that includes metadata for the data units stored in the CEG object that is identified by the CEG identifier.

In some implementations, the container index 220 may comprise a plurality of unit metadata entries 225. Each unit metadata entry 225 may relate to one or more data units 260. In some implementations, each unit metadata entry 225 may include the data unit identifier, a fingerprint, a reference count, a CEG identifier (“CEG ID”), a unit location, and compression information. The data unit and CEG identifiers are discussed above with reference to the manifest 200. The fingerprint may be a value derived by applying a function (e.g., a hash function) to all or some of the content of the data unit. The reference count may indicate the total number of records in the manifests 200 that reference the data unit. The compression information may indicate how the stored data unit is compressed or decompressed (whether compression was used, type of compression code, type of decompression code, decompressed size, a checksum value, etc.). In some examples, during a read operation, the compression information may be used to decompress a requested data unit.

In some implementations, the unit location may indicate the portion of (or position within) the CEG object 250 that stores the data unit (or a set of data units). The unit location may be information stored in a field (or in a combination of multiple fields) that deterministically identifies the storage location of the data unit(s). For example, the unit location may be recorded as two values (e.g., stored in two fields) that respectively identify a particular offset in the CEG object 250, and the data length of the data unit(s) stored at the specified offset. In another example, the unit location may be recorded as a single value (e.g., an offset in the CEG object 250). Other examples are possible.

In some implementations, a CEG object 250 may include a CEG header 240 and one or more data units 260. The header portion 240 may occupy a specified portion of a CEG object 250 (e.g., the first 64 kilobytes of the CEG object). Further, in some implementations, the CEG object 250 may include one or more groupings or “entities” 255, with each entity 255 including multiple data units 260. Each entity 255 may be compressed to reduce its stored size. In some implementations, the CEG header 240 may include one or more header entries 245. Each header entry 245 may include metadata regarding a different data unit 260 (or a set of data units 260) stored in the same CEG object 250. In some implementations, the header entry 245 for a data unit 260 may include a subset of the metadata in the unit metadata entry 225 (in the container index 220) for the same data unit 260. For example, a header entry 245 may include a first subset (i.e., data unit identifier, fingerprint, unit location, and compression information) of the metadata in the unit metadata entry 225, but may exclude a second subset (i.e., the reference count and the CEG identifier) of the metadata in the unit metadata entry 225.

In some implementations, a controller (e.g., storage controller 110 shown in FIG. 1) may use the unit metadata entry 225 (in the container index 220) to access a stored data unit via the container index path. An example processes for reading a data unit using container index metadata (e.g., in a unit metadata entry 225) is discussed below with reference to FIG. 4. Further, the controller may use the header entry 245 (in the CEG header 240) to access the stored data unit via the CEG path. An example processes for reading a data unit using the CEG object metadata (e.g., in the header entry 245) is discussed below with reference to FIG. 5.

Note that, while FIG. 2 shows one example of the data structures 200, implementations are not limited in this regard. For example, it is contemplated that the manifest 200, the container index 220, and the CEG objects 250 may include additional fields or elements, additional data structures, and so forth. In another example, it is contemplated that the unit metadata entry 225 and/or the header entry 245 may include additional fields, fewer fields, different fields, and so forth.

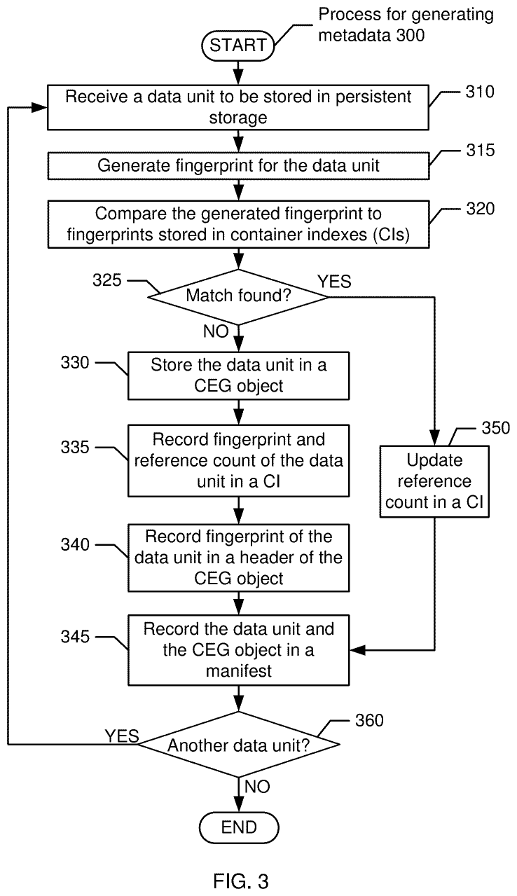

### FIG. 3—Example Process for Generating Metadata

FIG. 3 shows is an example process 300 for generating metadata of a deduplication storage system, in accordance with some implementations. For the sake of illustration, details of the process 300 may be described below with reference to FIGS. 1-2, which show examples in accordance with some implementations. However, other implementations are also possible.

In some examples, the process 300 may be performed using the storage controller 110 (shown in FIG. 1). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. In some implementations, the process 300 may be executed by a single processing thread. In other implementations, the process 300 may be executed by multiple processing threads in parallel (e.g., concurrently using the work map and executing multiple housekeeping jobs).

Block 310 may include receiving a data unit to be stored in a persistent storage of a deduplication storage system. Block 315 may include generating a fingerprint for the received data unit. Block 320 may include comparing the generated fingerprint to fingerprints stored in container indexes of the deduplication storage system. For example, referring to FIG. 1, the storage controller 110 receives a stream of data units (e.g., a backup item) to be stored in the system 105. The storage controller 110 generates fingerprints for the received data units, and compares the generated fingerprints to the fingerprints included in container indexes 160.

Referring again to FIG. 3, decision block 325 may include determining whether a match is found between the generated fingerprint and the fingerprints included in container indexes (CIs). If it is determined at decision block 325 that no match is found (“NO”), the process 300 may continue at block 330, including storing the data unit in a container entity group (“CEG”) object. For example, referring to FIG. 1, if no match is identified between the generated fingerprint of the received data unit and the fingerprints included in container indexes 160, the storage controller 110 stores the data unit in a new CEG object 170.

Referring again to FIG. 3, block 335 may include recording the fingerprint and a reference count of the data unit in a container index. For example, referring to FIG. 2, the container index “x” 220 includes multiple unit metadata entries 225, where each unit metadata entry 225 includes metadata for a different data unit 260 (or sets of data units 260). In some implementations, each unit metadata entry 225 may record the fingerprint (“Fingerprint”) and reference count (“Ref. Count”) for a corresponding data unit. Further, each unit metadata entry 225 may record the storage address of the corresponding data unit using a combination of an identifier of CEG object and a location (e.g., an offset in the identified CEG object). For example, the unit metadata entries 225 for data units “1,” “2,” and “3” include the CEG identifier “xA,” thereby indicating that these data units are stored in the CEG object “xA.” In another example, the unit metadata entries 225 for data units “4,” “5,” and “6” include the CEG identifier “xB,” thereby indicating that these data units are stored in the CEG object “xB.” In yet another example, the unit metadata entry 225 for data unit “7” includes the CEG identifier “xC,” thereby indicating that this data unit is stored in the CEG object “xC.”

Referring again to FIG. 3, block 340 may include recording the fingerprint of the data unit in a header of the CEG object. For example, referring to FIG. 2, the CEG header 240 of a CEG object 250 includes multiple header entries 245, where each header entry 245 includes a subset of metadata for a different data unit 260 that is stored in the CEG object “xA.” For example, the header entries 245 in CEG object “xA” include a subset of metadata for the data units “1,” “2,” and “3” that are stored in CEG object “xA.” In some implementations, each header entry 245 may record at least the fingerprint and the location for a corresponding data unit. However, the header entry 245 may exclude the reference count and CEG identifier for the corresponding data unit.

Referring again to FIG. 3, block 345 may include recording the data unit and the CEG object in a manifest. For example, referring to FIG. 2, the manifest 200 includes multiple entries to record a sequence of data units (e.g., representing a backup item). Each entry of the manifest 200 may record the unit identifier and CEG identifier for a data unit. In some implementations, the CEG identifier may include or encode an identifier for the container index 220. For example, as shown in FIG. 2, each CEG identifier (e.g., “xA,” “xB,” “xC”) may include a prefix (e.g., “x”) or other embedded portion that identifies the container index 220 (e.g., container index “x”) that includes metadata for the data units stored in the CEG object that is identified by the CEG identifier. Accordingly, the CEG identifiers “xA,” “xB,” and “xC” may be used to identify the container index “x” that includes metadata for the data units stored in the CEG objects “xA,” “xB,” and “xC.”

Referring again to FIG. 3, if it is determined at decision block 325 that a match is found (“YES”), the process 300 may continue at block 350, including updating a reference count for the data unit in the container index that indexes that data unit. After block 350, the process 300 may continue at block 345, including recording the data unit and the CEG object (that stores an existing copy of the data unit) in a manifest. For example, referring to FIG. 1, if a match is identified between the generated fingerprint of the received data unit and a fingerprint stored in a particular container index 160, the storage controller 110 determines that a duplicate of the data unit is already stored in an existing CEG object 170. Accordingly, the storage controller 110 increments the reference count (corresponding to the data unit) in the particular container index 160. Further, the storage controller 110 records, in a current manifest 150, information identifying the data unit and the existing CEG object 170.

Referring again to FIG. 3, decision block 360 may include determining whether another data unit is to be received. If so (“YES”), the process 300 may return to block 310 (i.e., to receive another data unit to be stored in persistent storage). Otherwise (“NO”), the process 300 may be completed.

### FIG. 4—Example Process for Reading Data Using Container Index Metadata

FIG. 4 shows is an example process 400 for reading data using container index metadata, in accordance with some implementations. In some examples, the process 400 may be performed using the storage controller 110 (shown in FIG. 1). The process 400 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 410 may include receiving a request to retrieve a data unit stored in a deduplication storage system. Block 420 may include identifying a manifest recording the data unit. Block 430 may include loading the identified manifest into a memory. Block 440 may include identifying a container index using the manifest. Block 450 may include loading the identified container index into the memory. For example, referring to FIGS. 1-2, the storage controller 110 receives a read request to access a data unit “3” stored in the remote storage 190 (e.g., as part of a stored backup item). The storage controller 110 identifies the manifest 200 that references the data unit “3,” and loads the manifest 200 into memory 115 (e.g., from the persistent storage 140 or the remote storage 190). The storage controller 110 reads the manifest 200 (loaded in memory 115) to determine that the data unit “3” is stored in the container entity group (CEG) object “xA.” Further, the storage controller 110 uses (e.g., by parsing or decoding) the CEG object identifier “xA” to obtain the container index identifier “x.” The storage controller 110 then loads the container index “x” into the memory 115 (e.g., from the persistent storage 140 or the remote storage 190).

Referring again to FIG. 4, block 460 may include determining, using the container index, a storage location of the data unit in a container entity group (CEG) object. Block 470 may include reading the data unit from the storage location in the CEG object. After block 470, the process 400 may be completed. For example, referring to FIGS. 1-2, the storage controller 110 reads the container index “x” (loaded in memory 115) to determine that the data unit “3” is stored in location “30” of the CEG object “xA.” The storage controller 110 then reads the data unit “3” from the location “30” in the CEG object “xA” (e.g., from the remote storage 190).

### FIG. 5—Example Process for Reading Data Using CEG Metadata

FIG. 5 shows is an example process 500 for reading data using container entity group (CEG) metadata, in accordance with some implementations. In some examples, the process 500 may be performed using the storage controller 110 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 510 may include receiving a request to retrieve a data unit stored in a deduplication storage system. Block 520 may include identifying a manifest recording the data unit. Block 530 may include loading the identified manifest into a memory. Block 540 may include identifying, using the manifest, a container entity group (CEG) object that stores the data unit. Block 550 may include loading a header portion of the CEG object into the memory.

For example, referring to FIGS. 1-2, the storage controller 110 receives a read request to access a data unit “3” stored in the remote storage 190. The storage controller 110 identifies the manifest 200 that references the data unit “3,” and loads the manifest 200 into memory 115 (e.g., from the persistent storage 140 or the remote storage 190). The storage controller 110 reads the manifest 200 (loaded in memory 115) to determine that the data unit “3” is stored in the container entity group (CEG) object “xA.” Further, the storage controller 110 loads the header portion 240 of the CEG object “xA” into the memory 115 (e.g., from the remote storage 190). In some implementations, the header portion 240 may occupy a specified amount of data located at the beginning of a CEG object (e.g., the first 64 kilobytes of the CEG object). In such implementations, the storage controller 110 may read the specified amount of data from the CEG object (i.e., without reading the remaining portion of the CEG object), and may then parse or otherwise obtain the header portion 240 from this amount of data from the CEG object.

Referring again to FIG. 5, block 560 may include determining, using the header portion, a storage location of the data unit stored in the CEG object. Block 570 may include reading the data unit from the determined storage location in the CEG object. After block 570, the process 500 may be completed. For example, referring to FIGS. 1-2, the storage controller 110 reads the header portion 240 of the CEG object “xA” (loaded in memory 115) to determine that the data unit “3” is stored in location “30” of the CEG object “xA.” The storage controller 110 then reads the data unit “3” from the location “30” in the CEG object “xA” (e.g., from the remote storage 190). In this manner, the storage controller 110 performs the read request without having to load a container index 160 from the persistent storage 140 (or remote storage 190) into the memory 115. Accordingly, the process 500 may reduce the number of input/output (I/O) transfers required to perform read requests, and may thereby improve the performance of the storage system 100.

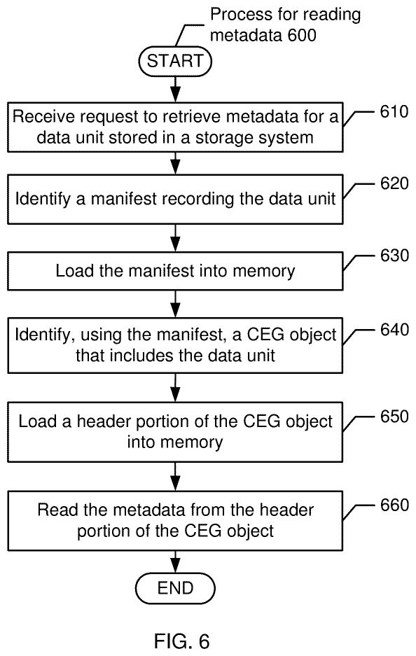

### FIG. 6—Example Process for Reading Metadata

FIG. 6 shows is an example process 600 for reading metadata, in accordance with some implementations. For example, the process 600 may be performed to collect a set of fingerprints (or other metadata) for stored data units (e.g., in order to replicate a stored backup item). In some examples, the process 600 may be performed using the storage controller 110 (shown in FIG. 1). The process 600 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 610 may include receiving a request to retrieve metadata for a data unit stored in a deduplication storage system. Block 620 may include identifying a manifest recording the data unit. Block 630 may include loading the identified manifest into a memory. Block 640 may include identifying, using the manifest, a container entity group (CEG) object that stores the data unit. Block 650 may include loading a header portion of the CEG object into the memory. Block 660 may include reading the metadata from the header portion of the CEG object. After block 660, the process 600 may be completed.

For example, referring to FIGS. 1-2, the storage controller 110 receives a read request to retrieve the fingerprints for data units “2” and “3” (e.g., stored in remote storage 190). The storage controller 110 identifies the manifest 200 that references the data units “2” and “3,” and loads the manifest 200 into memory 115 (e.g., from the persistent storage 140 or the remote storage 190). The storage controller 110 reads the manifest 200 (loaded in memory 115) to determine that the data units “2” and “3” are stored in the CEG object “xA.” Further, the storage controller 110 loads the header portion 240 of the CEG object “xA” into the memory 115 (e.g., from the remote storage 190), and then reads the fingerprints for the data units “2” and “3” from the header portion 240.

### FIG. 7—Example Process for Rebuilding a Container Index

FIG. 7 shows is an example process 700 for rebuilding a container index, in accordance with some implementations. In some examples, the process 700 may be performed using the storage controller 110 (shown in FIG. 1). The process 700 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 710 may include receiving a request to rebuild a container index in a deduplication storage system. Block 720 may include instantiating a replacement container index. For example, referring to FIGS. 1-2, the storage controller 110 receives a request to rebuild the container index “x” (e.g., responsive to a determination that a container index “x” has been corrupted or lost). The storage controller 110 then instantiates a replacement version of the container index “x” (e.g., an empty container index 220) in the memory 115.

Referring again to FIG. 7, block 730 may include identifying a set of container entity group (CEG) objects associated with the container index. Block 740 may include loading header portions of the CEG objects into memory. Block 750 may include reading data unit metadata from the header portions. Block 760 may include copying the data unit metadata into the replacement container index. For example, referring to FIGS. 1-2, the storage controller 110 identifies a set of CEG objects (i.e., CEG objects “xA,” “xB,” “xC”) that have CEG identifiers with the prefix “x,” which indicates that the data unit metadata for these CEG objects is to be stored in the container index “x.” Further, for each of the identified CEG objects, the storage controller 110 loads the header portion 240 of the CEG object into the memory 115 (e.g., from the remote storage 190), reads the metadata values (e.g., “Unit ID,” “Fingerprint,” Location,” “Compression”) stored in the header entries 245 of the header portion 240, and populates the metadata values into the corresponding unit metadata entries 225 in the replacement container index “x.”

Referring again to FIG. 7, block 770 may include identifying a set of manifests associated with the container index. Block 780 may include incrementing, in the replacement container index, reference counts based on the data units referenced in the set of manifests. After block 780, the replacement container index is ready for use, and the process 700 may be completed. For example, referring to FIGS. 1-2, the storage controller 110 reads the manifests 150 (e.g., from the persistent storage 140 or the remote storage 190), and identifies a set of manifests 150 that each include at least one reference to the container index “x” (e.g., in a prefix of a CEG identifier stored in a manifest record). The storage controller 110 then determines, for each data unit listed in the unit metadata entries 225 of the container index “x,” the total number of references to that data unit (also referred to as the “reference count”) that are recorded in the identified set of manifests 150. Further, the storage controller 110 updates the unit metadata entries 225 (in container index “x”) to record the reference count for each data unit listed in the unit metadata entries 225. In this manner, the replacement container index “x” is completed.

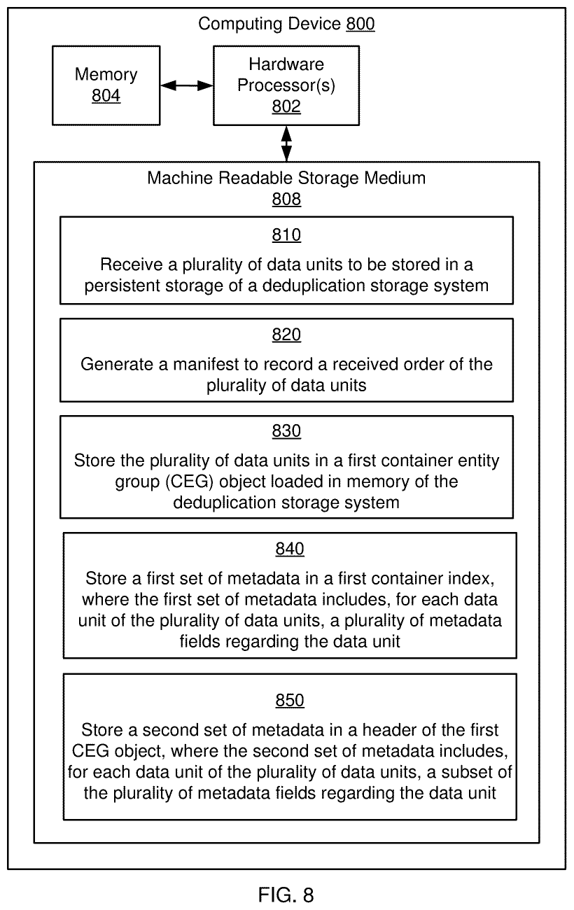

### FIG. 8—Example Computing Device

FIG. 8 shows a schematic diagram of an example computing device 800. In some examples, the computing device 800 may correspond generally to some or all of the storage system 100 (shown in FIG. 1). As shown, the computing device 800 may include a hardware processor 802, a memory 804, and machine-readable storage 805 including instructions 810-860. The machine-readable storage 805 may be a non-transitory medium. The instructions 810-860 may be executed by the hardware processor 802, or by a processing engine included in hardware processor 802.

Instruction 810 may be executed to receive a plurality of data units to be stored in a persistent storage of a deduplication storage system. Instruction 820 may be executed to generate a manifest to record a received order of the plurality of data units. Instruction 830 may be executed to store the plurality of data units in a first container entity group (CEG) object loaded in memory of the deduplication storage system. For example, referring to FIGS. 1-2, the storage controller 110 receives a stream of data units (e.g., a backup item) to be stored in the system 105. The storage controller 110 generates fingerprints for the received data units, and compares the generated fingerprints to the fingerprints included in container indexes 160. If no match is identified between the generated fingerprint of the received data unit and the fingerprints included in container indexes 160, the storage controller 110 stores the data unit in a new CEG object 170. Further, the storage controller 110 records the intake order of the data units and the CEG identifiers (i.e., for the CEG objects 170 that store each data unit) in a manifest 200.

Referring again to FIG. 8, instruction 840 may be executed to store a first set of metadata in a first container index, where the first set of metadata includes, for each data unit of the plurality of data units, a plurality of metadata fields regarding the data unit. For example, referring to FIGS. 1-2, the storage controller 110 generates a container index “x” 220 that includes multiple unit metadata entries 225, where each unit metadata entry 225 includes metadata for a different data unit 260 (or sets of data units 260). In some implementations, each unit metadata entry 225 may record the fingerprint (“Fingerprint”) and reference count (“Ref. Count”) for a corresponding data unit. Further, each unit metadata entry 225 may record the storage address of the corresponding data unit using a combination of an identifier of CEG object and a location (e.g., an offset in the identified CEG object).

Referring again to FIG. 8, instruction 850 may be executed to store a second set of metadata in a header of the first CEG object, where the second set of metadata includes, for each data unit of the plurality of data units, a subset of the plurality of metadata fields regarding the data unit. For example, referring to FIGS. 1-2, the storage controller 110 generates a CEG object 250 that includes a CEG header 240 (i.e., a header portion). The CEG header 240 includes multiple header entries 245, where each header entry 245 includes a subset of metadata for a different data unit 260 that is stored in the CEG object “xA.” For example, the header entries 245 in CEG object “xA” include a subset of metadata for the data units “1,” “2,” and “3” that are stored in CEG object “xA.” In some implementations, each header entry 245 may record the fingerprint and the location for a corresponding data unit. However, the header entry 245 may exclude the reference count and CEG identifier for the corresponding data unit.

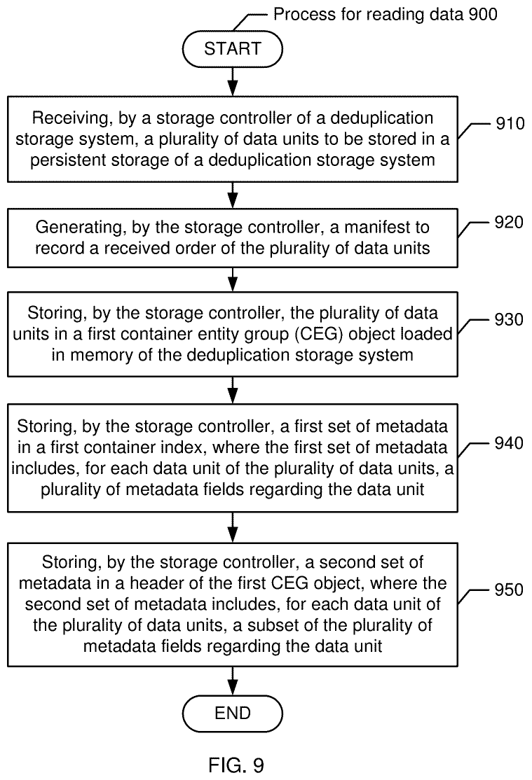

### FIG. 9—Example Process for Generating Metadata

FIG. 9 shows is an example process 900 for generating metadata of a deduplication storage system, in accordance with some implementations. In some examples, the process 900 may be performed using the storage controller 110 (shown in FIG. 1). The process 900 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 910 may include receiving, by a storage controller of a deduplication storage system, a plurality of data units to be stored in a persistent storage of a deduplication storage system. Block 920 may include generating, by the storage controller, a manifest to record a received order of the plurality of data units. Block 930 may include storing, by the storage controller, the plurality of data units in a first container entity group (CEG) object loaded in memory of the deduplication storage system.

Block 940 may include storing, by the storage controller, a first set of metadata in a first container index, where the first set of metadata includes, for each data unit of the plurality of data units, a plurality of metadata fields regarding the data unit. Block 950 may include storing, by the storage controller, a second set of metadata in a header of the first CEG object, where the second set of metadata includes, for each data unit of the plurality of data units, a subset of the plurality of metadata fields regarding the data unit. Blocks 910-950 may correspond generally to the examples described above with reference to instructions 810-850 (shown in FIG. 8).

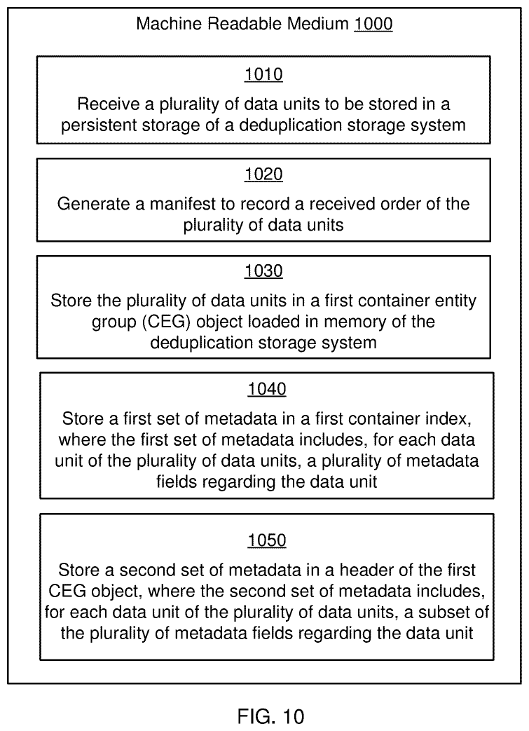

### FIG. 10—Example Machine-Readable Medium

FIG. 10 shows a machine-readable medium 1000 storing instructions 1010-1050, in accordance with some implementations. The instructions 1010-1050 can be executed by a single processor, multiple processors, a single processing engine, multiple processing engines, and so forth. The machine-readable medium 1000 may be a non-transitory storage medium, such as an optical, semiconductor, or magnetic storage medium. The instructions 1010-1050 may correspond generally to the examples described above with reference to instructions 810-850 (shown in FIG. 8).

Instruction 1010 may be executed to receive a plurality of data units to be stored in a persistent storage of a deduplication storage system. Instruction 1020 may be executed to generate a manifest to record a received order of the plurality of data units. Instruction 1030 may be executed to store the plurality of data units in a first container entity group (CEG) object loaded in memory of the deduplication storage system.

Instruction 1040 may be executed to store a first set of metadata in a first container index, where the first set of metadata includes, for each data unit of the plurality of data units, a plurality of metadata fields regarding the data unit. Instruction 1050 may be executed to store a second set of metadata in a header of the first CEG object, where the second set of metadata includes, for each data unit of the plurality of data units, a subset of the plurality of metadata fields regarding the data unit.

### Conclusion

In accordance with some implementations of the present disclosure, a controller of a deduplication storage system may receive a data unit at initial ingest, and may store the data unit in a container entity group (“CEG”) object. The controller may also generate metadata for the data unit, and may store this data unit metadata in a container index. Further, the controller may store a metadata subset in a portion of the CEG object (e.g., a header portion). Upon receiving a read request, the controller may identify the CEG object that stores the data unit, and may load the metadata subset of the CEG object from persistent storage into memory. The controller may read the metadata subset to determine the location of the data unit stored in the CEG object, and may then access the data unit using the determined location. In this manner, the controller may access the data unit without having to load the container index from persistent storage into memory.

Further, the metadata subset of the CEG object may be used to replace a lost or corrupted container index. The controller may identify a set of CEG objects associated with the lost container index, load the metadata subset of the CEG object into memory, and populate the metadata subset into a replacement container index. The controller may then identify a set of manifests that each include at least one reference to the lost container index, determine the total reference counts in the identified set of manifests, and then populate the reference counts into the replacement container index. In this manner, the replacement container index is populated with the same metadata that would have been stored in the lost container index, and can then be used for deduplication of stored data.

Note that, while FIGS. 1-10 show various examples, implementations are not limited in this regard. For example, referring to FIG. 1, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
a processor;
a memory; and
a machine-readable storage storing instructions, the instructions executable by the processor to:
receive a plurality of data units to be stored in a persistent storage of a deduplication storage system;
generate a manifest to record a received order of the plurality of data units;
store the plurality of data units in a first container entity group (CEG) object;
store a first set of metadata in a first container index, wherein the first set of metadata includes, for each data unit of the plurality of data units, a plurality of metadata fields regarding the data unit; and
store a second set of metadata in a header of the first CEG object, wherein the second set of metadata includes, for each data unit of the plurality of data units, a subset of the plurality of metadata fields regarding the data unit.

2. The computing device of claim 1, including instructions executable by the processor to:
receive a read request for a particular data unit stored in the persistent storage;
identify a second manifest based on the read request for the particular data unit;
load the second manifest into the memory;
identify, using the second manifest loaded in the memory, a second CEG object that stores the particular data unit;
load a header portion of the second CEG object into the memory;
determine, using the header portion loaded in the memory, a storage location of the particular data unit in the second CEG object; and
read the particular data unit from the determined storage location in the second CEG object.

3. The computing device of claim 2, wherein a second container index stores metadata regarding the particular data unit, and wherein the second container index is not loaded into the memory to perform the read request for the particular data unit.

4. The computing device of claim 3, including instructions executable by the processor to:
receive a read request for a different data unit stored in the persistent storage;
identify a third manifest based on the read request for the different data unit;
load the third manifest into the memory;
identify a third container index using the third manifest loaded in the memory, wherein the third container index stores metadata regarding the different data unit;
load the third container index into the memory;
determine, using the third container index loaded in the memory, a particular storage location of the different data unit in a third CEG object; and
read the different data unit from the particular storage location in the third CEG object.

5. The computing device of claim 1, wherein:
the first set of metadata includes a data unit identifier, a fingerprint, a reference count, a CEG identifier, a storage location, and compression information; and
the second set of metadata includes the data unit identifier, the fingerprint, the storage location, and the compression information, wherein the second set of metadata excludes the reference count and the CEG identifier.

6. The computing device of claim 1, including instructions executable by the processor to:
detect a corruption of the first container index; and
in response to a detection of the corruption of the first container index, rebuild the first container index using the second set of metadata stored in the header of the CEG object.

7. The computing device of claim 6, including instructions executable by the processor to, in response to the detection of the corruption of the first container index:
instantiate a replacement version of the first container index;
identify a set of CEG objects associated with the first container index;
load header portions of the set of CEG objects into the memory;
read the subset of the plurality of metadata fields from the header portions loaded in the memory; and
copy the subset of the plurality of metadata fields into the replacement version of the first container index.

8. The computing device of claim 7, including instructions executable by the processor to, in response to the detection of the corruption of the first container index:
identify a set of manifests associated with the first container index; and
increment, in the replacement version of the first container index, reference counts based on a set of data units referenced in the set of manifests.

9. A method comprising:
receiving, by a storage controller of a deduplication storage system, a plurality of data units to be stored in a persistent storage of a deduplication storage system;
generating, by the storage controller, a manifest to record a received order of the plurality of data units;
storing, by the storage controller, the plurality of data units in a first container entity group (CEG) object;
storing, by the storage controller, a first set of metadata in a first container index, wherein the first set of metadata includes, for each data unit of the plurality of data units, a plurality of metadata fields regarding the data unit; and
storing, by the storage controller, a second set of metadata in a header of the first CEG object, wherein the second set of metadata includes, for each data unit of the plurality of data units, a subset of the plurality of metadata fields regarding the data unit.

10. The method of claim 9, comprising:
receiving a read request for a particular data unit stored in the persistent storage;
identifying a second manifest based on the read request for the particular data unit;
loading the second manifest into the memory;
identifying, using the second manifest loaded in the memory, a second CEG object that stores the particular data unit;
loading a header portion of the second CEG object into the memory;
determining, using the header portion loaded in the memory, a storage location of the particular data unit in the second CEG object; and
reading the particular data unit from the determined storage location in the second CEG object.

11. The method of claim 10, wherein a second container index stores metadata regarding the particular data unit, and wherein the second container index is not loaded into the memory to perform the read request for the particular data unit.

12. The method of claim 9, wherein:
the first set of metadata includes a data unit identifier, a fingerprint, a reference count, a CEG identifier, a storage location, and compression information; and
the second set of metadata includes the data unit identifier, the fingerprint, the storage location, and the compression information, wherein the second set of metadata excludes the reference count and the CEG identifier.

13. The method of claim 9, comprising:
detecting a corruption of the first container index; and
in response to detecting the corruption of the first container index, rebuilding the first container index using the second set of metadata stored in the header of the CEG object.

14. The method of claim 13, comprising, in response to detecting the corruption of the first container index:
instantiating a replacement version of the first container index;
identifying a set of CEG objects associated with the first container index;
loading header portions of the set of CEG objects into the memory;
reading the subset of the plurality of metadata fields from the header portions loaded in the memory; and
copying the subset of the plurality of metadata fields into the replacement version of the first container index.

15. A non-transitory machine-readable medium storing instructions that upon execution cause a processor to:
receive a plurality of data units to be stored in a persistent storage of a deduplication storage system;
generate a manifest to record a received order of the plurality of data units;
store the plurality of data units in a first container entity group (CEG) object;
store a first set of metadata in a first container index, wherein the first set of metadata includes, for each data unit of the plurality of data units, a plurality of metadata fields regarding the data unit; and
store a second set of metadata in a header of the first CEG object, wherein the second set of metadata includes, for each data unit of the plurality of data units, a subset of the plurality of metadata fields regarding the data unit.

16. The non-transitory machine-readable medium of claim 15, including instructions that upon execution cause the processor to:
receive a read request for a particular data unit stored in the persistent storage;
identify a second manifest based on the read request for the particular data unit;
load the second manifest into the memory;
identify, using the second manifest loaded in the memory, a second CEG object that stores the particular data unit;
load a header portion of the second CEG object into the memory;
determine, using the header portion loaded in the memory, a storage location of the particular data unit in the second CEG object; and
read the particular data unit from the determined storage location in the second CEG object.

17. The non-transitory machine-readable medium of claim 16, wherein a second container index stores metadata regarding the particular data unit, and wherein the second container index is not loaded into the memory to perform the read request for the particular data unit.

18. The non-transitory machine-readable medium of claim 17, including instructions that upon execution cause the processor to:
receive a read request for a different data unit stored in the persistent storage;
identify a third manifest based on the read request for the different data unit;
load the third manifest into the memory;
identify a third container index using the third manifest loaded in the memory, wherein the third container index stores metadata regarding the different data unit;
load the third container index into the memory;
determine, using the third container index loaded in the memory, a particular storage location of the different data unit in a third CEG object; and
read the different data unit from the particular storage location in the third CEG object.

19. The non-transitory machine-readable medium of claim 15, wherein:
the first set of metadata includes a data unit identifier, a fingerprint, a reference count, a CEG identifier, a storage location, and compression information; and
the second set of metadata includes the data unit identifier, the fingerprint, the storage location, and the compression information, wherein the second set of metadata excludes the reference count and the CEG identifier.

20. The non-transitory machine-readable medium of claim 15, including instructions that upon execution cause the processor to:
in response to a request to replace the first container index:
instantiate a replacement version of the first container index;
identify a set of CEG objects associated with the first container index;
load header portions of the set of CEG objects into the memory;
read the subset of the plurality of metadata fields from the header portions loaded in the memory; and
copy the subset of the plurality of metadata fields into the replacement version of the first container index.
